(19) United States
(12) Patent Application Publication
(10) Pub. No.: US 2012/0130733 A1
(43) Pub. Date: May 24, 2012

(54) SYSTEMS AND METHODS FOR PROVIDING VALUE-BASED INSURANCE DESIGN AND BENEFITS

(75) Inventor: THOMAS W. KERR, Pittsburgh, PA (US)

(73) Assignee: HIGHMARK INC., PITTSBURGH, PA (US)

(21) Appl. No.: 13/275,861

(22) Filed: Oct. 18, 2011

Related U.S. Application Data
(60) Provisional application No. 61/394,258, filed on Oct. 18, 2010.

(51) Int. Cl. G06Q 50/22

(52) U.S. Cl. 705/2

(57) ABSTRACT

Systems and methods for the cost-effective implementation of health care. Systems and methods are provided whereby subscribers to a health plan, upon qualification, may participate in health plan administrations that utilize evidence-based approaches to improve both employee health and reduce overall healthcare costs. Subscribers suffering from a medical condition may be identified and provided with a condition/disease management program to follow. If subscribers to the health plan comply with the condition/disease management program, they are provided with incentives related to that specific medical condition. In some examples, subscribers may enter the system through the term of the healthcare plan, thus providing a dynamic mechanism for administration and delivery of cost-efficient healthcare.

### RELATED APPLICATIONS

This application claims the benefit under 35 U.S.C. §119(e) of the earlier filing date of U.S. Provisional Application Ser. No. 61/394,258 filed on Oct. 18, 2010.

### BACKGROUND OF THE INVENTION

1. Field of the Invention

This application discloses an invention which relates, generally and in various embodiments, to systems and methods for administering and implementing medical benefits using a value-based and dynamic approach.

2. Description of the Background

The administration of healthcare in the United States is presently undergoing a substantial re-evaluation. For some patients, the high costs of healthcare represent a significant impediment to the adequate treatment for chronic conditions. Indeed, studies have shown that when copayments double, patients with chronic conditions are less likely to take their medication as prescribed. For example, in one study patients with asthma, diabetes, and gastric disorders had 17% more visits to the emergency room and 10% more inpatient admissions than the normal patient population. Goldman, Journal of the American Medical Association (2004).

The healthcare industry is faced with the issue of how benefit costs can be reduced, while at the same time maintaining quality healthcare for the patient. Some prior-art implementations designed to achieve those parallel goals have failed. To reduce healthcare benefit costs, some employers have implemented benefit designs with increased employee cost sharing (e.g., higher deductibles, increased copayments, and more coinsurance). However, the result of such programs is reduced quality of medical care. For example, when employees with chronic health conditions skip medications, do not receive needed screenings, or delay visits to the doctor because of increased costs, the results are often more frequent trips to the emergency room or the need for even more expensive care. Additionally, healthy employees may not receive preventative care due to higher out-of-pocket costs and, thus, may incur higher costs in the future because serious medical conditions are not identified earlier when they are less expensive to treat.

Traditional benefits systems are ill-suited to address these concerns. In a typical implementation of healthcare benefits, an employee is typically only permitted to make changes to their health plan once per year, unless a qualifying event such as a marriage, birth of a child, etc. occurs. The changes to the plan may be what services are selected to be covered by the health plan, the amount of the deductible, the level of co-insurance, the amount of the co-pay, etc. Unfortunately, many employees make short-term healthcare decisions based on the short-term costs (e.g., the deductible and/or the necessary co-pay) instead of what is best for their health (and thus the long-term costs to the health plan).

### SUMMARY OF THE INVENTION

The present invention provides systems and methods for the cost-effective implementation of health care. The present invention achieves this goal while at the same time maintaining a high level of medical care for patients. The present systems and methods allow subscribers to a health plan, upon qualification, to participate in health plan administrations that utilize evidence-based approaches to improve both employee health and overall employer healthcare costs. The present systems and methods also reduce barriers for subscribers to obtain healthcare and to comply with evidence-based programs that will improve the patient's outcome with regard to targeted conditions or diseases. By using the present systems and methods, healthcare administrators are able to shape health plans by determining which subscriber behaviors should be encouraged and providing incentives to the subscriber for compliance with medical programs that promote those desired behaviors (the desired behaviors are part of evidence-based condition/disease management programs that address a patient's medical condition or disease). Subscribers may alter the structure of their medical benefits throughout the plan year, thereby providing a dynamic tool for the value-based implementation of health plans. The present systems and methods may be implemented on a computing system.

### BRIEF DESCRIPTION OF THE DRAWINGS

Various embodiments of the invention are described herein in by way of example in conjunction with the following figures, wherein like reference characters designate the same or similar elements.

FIG. 1 illustrates a high-level representation of a benefit management system according to various embodiments; and

FIG. 2 illustrates various embodiments of a computing system of the benefit management system of FIG. 1.

### DETAILED DESCRIPTION OF THE INVENTION

It is to be understood that at least some of the figures and descriptions of the invention have been simplified to illustrate elements that are relevant for a clear understanding of the invention, while eliminating, for purposes of clarity, other well-known elements that those of ordinary skill in the art will appreciate may also comprise a portion of the invention.

As described in more detail hereinbelow, aspects of the invention may be implemented by a computing device and/or a computer program stored on a computer-readable medium. The computer-readable medium may comprise a disk, a device, and/or a propagated signal.

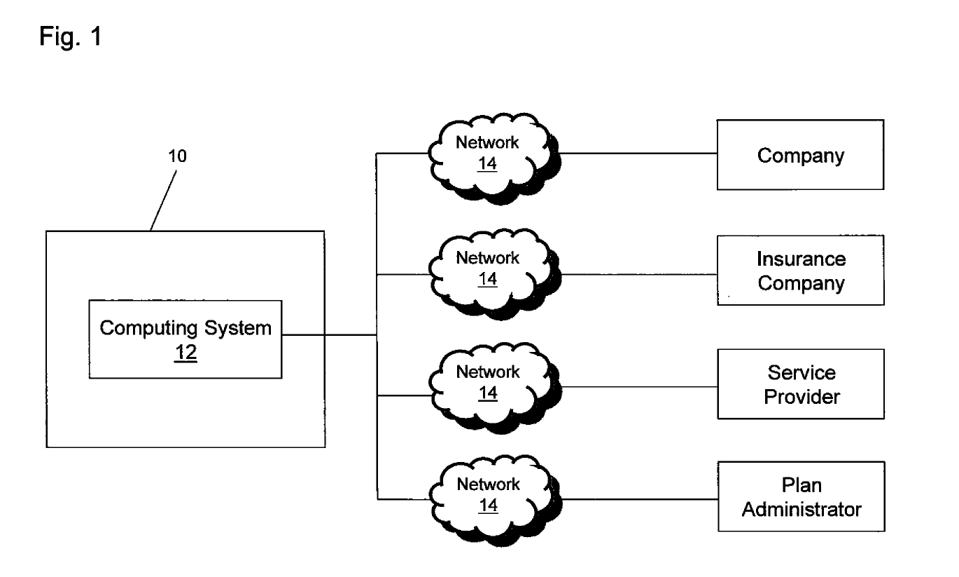

FIG. 1 illustrates a high-level representation of a benefit management system 10 according to various embodiments. The benefit management system 10 may be utilized to manage value-based healthcare benefits for a plurality of entities and their respective employees. Individuals who participate in a health plan may be referred to either as employees, patients, or subscribers. For purposes of simplicity, the benefit management system 10 will be described in the context of its use as a medical benefit management system. However, it will be appreciated that the benefit management system 10 may be employed to manage any number and type of benefits.

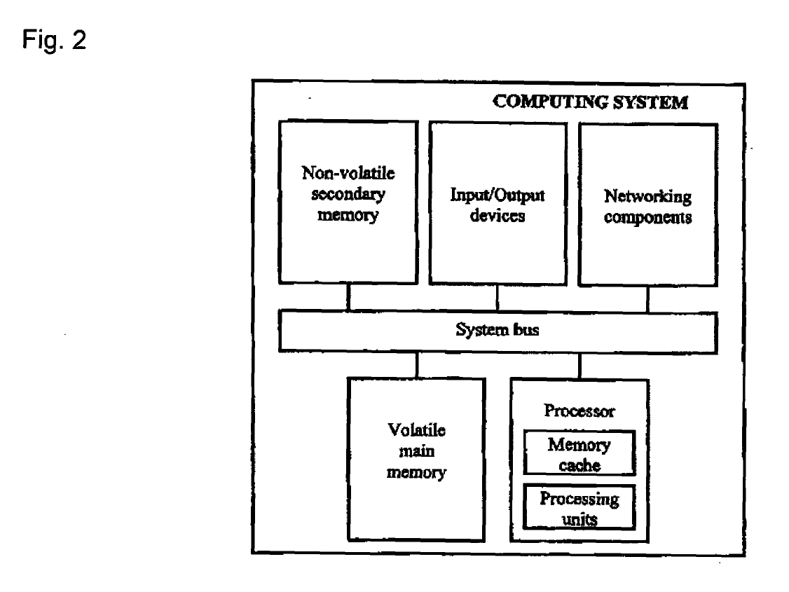

The benefit management system 10 includes a computing system 12. The computing system 12 may be any suitable type of computing system, and various embodiments of the computing system 12 are described in more detail hereinbelow with respect to FIG. 2.

As shown in FIG. 1, the computing system 12 is communicably connected to computing systems 16 of a plurality of different entities (e.g., an insurance company, a company which has a benefit plan for its employees, a service provider, a third-party plan administrator) via one or more networks 14. Users of the system 10 may employ these networks 14 to undertake such tasks as enrolling in value-based benefit plans, checking compliance of employees with the plans, or changing benefits for employees.

Each of the networks 14 may include any type of delivery system including, but not limited to, a local area network (e.g., Ethernet), a wide area network (e.g. the Internet and/or World Wide Web), a telephone network (e.g., analog, digital, wired, wireless, PSTN, ISDN, GSM, GPRS, and/or xDSL), a packet-switched network, a radio network, a television network, a cable network, a satellite network, and/or any other wired or wireless communications network configured to carry data. Each network 14 may include elements, such as, for example, intermediate nodes, proxy servers, routers, switches, and adapters configured to direct and/or deliver data. In general, the computing system 12 may be structured and arranged to communicate with the computing systems 16 of the different entities via the network 14 using various communication protocols (e.g., HTTP, TCP/IP, UDP, WAP, WiFi, BLUETOOTH) and/or to operate within or in concert with one or more other communications systems.

Although only one insurance company, one company which has a benefit plan for its employees, one service provider, and one third-party plan administrator is shown in FIG. 1, it is appreciated that the computing system 12 may be communicably connected to the respective computing systems 16 of any number and combination of such entities, via the network 14. It is also appreciated that the computing system 12 may be communicably connected to any number of other computing systems not specifically shown in FIG. 1 via the network 14. Additionally, although each network 14 is shown as a separate network in FIG. 1, it will be appreciated that a given network 14 may be common to one or more of the other networks 14 shown in FIG. 1.

The benefit management system 10 may be utilized, for example to (1) allow such employees, upon qualification, to participate in health plan administrations that utilize evidence-based approaches to improve both employee health and overall employer healthcare costs, (2) reduce barriers for employees in obtaining healthcare and in increasing compliance with evidence-based programs that will improve the patient's outcome with regard to targeted conditions or diseases, (3) reduce employer costs associated with healthcare over time, (4) improve overall employee productivity by reducing absenteeism and presenteeism in the workforce, (5) allow healthcare administrators to shape health plans by determining which behaviors should be encouraged and providing incentives to the patient for compliance with medical programs that promote those desired behaviors (the desired behaviors are part of evidence-based condition/disease management programs that address a patient's medical condition or disease), and (6) facilitate the alteration of the structure of an employee's benefits throughout the plan year, thereby providing a dynamic tool for the value-based implementation of health plans.

According to various embodiments, one or more modules may be utilized to realize the functionality of the benefit management system 10. For example, a registration module may be utilized to register a particular employer to the benefit management system, an account module may be utilized to set the parameters of the benefit plan offered by the employer to its employees, a selection module may be utilized to change the benefits provided to a given employee dynamically (i.e., throughout the course of the term of a health care plan), a records module may be utilized to track the costs associated with the benefits utilized by the employee, etc.

The modules may be implemented in hardware, firmware, software and combinations thereof, For embodiments utilizing software, the software may utilize any suitable computer language (e.g., C, C++, Java, JavaScript, Visual Basic, VBScript, Delphi) and may be embodied permanently or temporarily in any type of machine, component, physical or virtual equipment, storage medium, or propagated signal capable of delivering instructions to a device. The modules (e.g., software application, computer program) may be stored on a computer-readable medium (e.g., disk, device, and/or propagated signal) such that when a computer reads the medium, the functions described herein are performed.

According to various embodiments, the benefit management system 10 includes a plurality of modules. According to some embodiments, the functionality of two or more of the modules may be combined into a single module. For embodiments where the computing system 12 includes more than one computing device, the modules may be distributed across two or more of the computing devices.

The system 10 may be employed to implement methods for providing healthcare benefit systems which offer (1) flexibility to both administrators and employees and (2) a clinically sensitive approach to cost sharing for healthcare. The systems and methods allow healthcare administrators to shape health plans by determining which behaviors should be encouraged and providing incentives to the patient for compliance with medical programs that promote those desired behaviors. In some implementations, the systems and methods allow employees to alter the structure of the healthcare plan in response to those desired behaviors.

The system 10 enables health plan administrators to implement a fully integrated, voluntary program that targets the appropriate employees and provides those employees with an opportunity for enhanced benefits for services that are proven to be clinically effective in meeting their specific health needs.

The system 10 may be utilized to allow an employee 10 to dynamically change their health plan benefits throughout a plan year to participate in one or more condition/disease management programs. For example, a health plan administrator may choose to make it more affordable for members who have diabetes to obtain care that is proven to help manage their condition. That may include lower cost-sharing on insulin and other prescription drugs; glucometer and supplies, dilated retinal exam, hemoglobin A1c and other screenings; and office visits related to monitoring their diabetes. Responsive to the lower cost to obtain such care, an employee may utilize the system 10 to dynamically change their health care benefits to take better advantage of the new affordability of the diabetes care.

According to various embodiments, health plan administrators may utilize the system 10 to implement a method that lowers an employee's cost to participate in a particular condition/disease management program. For example, a health risk assessment may be performed for an employee, and the results of the health risk assessment are utilized to determine if the employee is eligible for participation in one or more condition/disease management programs. A health plan administrator may then allow the employee to dynamically enroll in one or more condition/disease management programs for which the employee is eligible. For any services related to the one or more condition/disease management program the employee enrolls in, the deductible may be waived, the cost of the supplies or medications may be lowered, or other incentive provided.

According to various implementations, the participation in and compliance with the requirements of the condition/disease management programs may be monitored, and if the patient complies with the requirements, such behavior will be rewarded through incentives such as the lower prices, the waived deductible, or other incentive.

According to various implementations, the continuation of the incentives provided to the employee for a particular condition/disease management program is contingent upon the employee's compliance with the requirements of the particular condition/disease management program. Compliance assessments may occur at predetermined time periods (e.g., once per quarter, every six months). If a compliance assessment indicates that the employee is not in compliance with the requirements of the particular condition/disease management program, the incentives associated with the particular condition/disease management program are no longer provided to the employee (the employee's coverage returns to the non-incentivized level).

According to various implementations, as a condition for continuing to receive the incentives associated with a given condition/disease management program, the employee may be required to demonstrate positive results associated with that condition/disease (e.g., lowered blood pressure) within a predetermined time period. If the patient fails to demonstrate those results within the given predetermined time period, the employee's coverage may return to the non-incentivized level.

According to various embodiments, the system 10 may be employed to implement value-based healthcare programs which address such chronic conditions as asthma, coronary artery disease, congestive heart failure, chronic obstructive pulmonary disease (COPD), depression, diabetes, high cholesterol, and high blood pressure. The incentives for participation in programs to address those conditions may include lower costs for prescriptions for medications, office visits, and screenings related to those conditions. Employees with covered conditions may qualify automatically for the value-based healthcare program when they initially enroll for their benefits. The particular nature of the implementation is flexible; for example, in some implementations the plan administrator may choose to reduce costs on drugs or office visits only.

According to various implementations, the employees may only qualify for participation in the value-based program if they contact a professional such as a health coach. In some implementations, employees may qualify as long as they comply with evidence-based protocols and continue to work with the health coach. Benefits for the employee may be adjusted during the plan year if the required protocols are not followed. Cost sharing may be adjusted at a member-based level based on the compliance of each family member. In some implementations cost sharing may be adjusted after a member completes initial requirements with no benefit changes during the year. Alternatively, cost sharing may be adjusted only at the contract level, i.e. only the employee has to follow the required protocols, but all members on the contract are eligible for reduced cost-sharing.

FIG. 2 illustrates various embodiments of the computing system 12. The computing system 12 may be embodied as one or more computing devices, and includes networking components such as Ethernet adapters, non-volatile secondary memory such as magnetic disks, input/output devices such as keyboards and visual displays, volatile main memory, and a processor. Each of these components may be communicably connected via a common system bus. The processor includes processing units and on-chip storage devices such as memory caches.

According to various embodiments, the computing system 12 includes one or more modules are implemented in software, and the software is stored in non-volatile memory devices while not in use. When the software is needed, the software is loaded into volatile main memory. After the software is loaded into volatile main memory, the processor reads software instructions from volatile main memory and performs useful operations by executing sequences of the software instructions on data which is read into the processor from volatile main memory. Upon completion of the useful operations, the processor writes certain data results to volatile main memory.

Nothing in the above description is meant to limit the invention to any configuration or implementation of elements. Many substitutions are contemplated within the scope of the invention and will be apparent to those skilled in the art. The embodiments described herein were presented by way of example only and should not be used to limit the scope of the invention.

Although the invention has been described in terms of particular embodiments in this application, one of ordinary skill in the art, in light of the teachings herein, can generate additional embodiments and modifications without departing from the spirit of, or exceeding the scope of, the described invention. Accordingly, it is understood that the drawings and the descriptions herein are proffered only to facilitate comprehension of the invention and should not be construed to limit the scope thereof.

What is claimed is:

1. A method of administering healthcare benefits, the method comprising:
determining if a subscriber to a health plan is eligible for participation in a condition/disease management program based on a health risk assessment performed on the subscriber;
dynamically enrolling the subscriber in the condition/disease management program based on said health risk assessment utilizing a computing system; and
providing the subscriber with an incentive for complying with requirements of the condition/disease management program.

2. The method of claim 1, wherein said subscriber may enroll in said condition/disease management program at any time during a term of said health plan.

3. The method of claim 1, wherein said health risk assessment comprises determining a medical condition that said subscriber suffers from.

4. The method of claim 3, wherein said condition/disease management program is tailored to said medical condition.

5. The method of claim 4, wherein said incentive relates to said medical condition.

5. The method of claim 5, wherein said incentive is selected from the group consisting of waiving a deductible for said subscriber, reducing costs of medical supplies related to said medical condition, reducing costs of diagnostic screenings related to said medical condition, and reducing a cost of medications used to treat or manage said medical condition.

6. The method of claim 1, further comprising the step of monitoring said subscriber's compliance with said condition/disease management program.

7. The method of claim 1, wherein said condition/disease management program is selected from the group consisting of improved behavior relating to said medical condition, increased testing of a status of said medical condition, more frequent visits to a medical professional for assessment of said medical condition, and consistent ingestion of medications for said medical condition.

8. The method of claim 7, wherein said medical condition is selected from the group consisting of diabetes mellitus and high blood pressure.

9. The method of claim 8, wherein said medical condition is diabetes.

10. The method of claim 9, wherein said improved behavior comprises reduced intake of sugar-containing foods.

11. The method of claim 9, wherein said testing comprises assessment of blood glucose levels.
